(19) United States
(12) Patent Application Publication
(10) Pub. No.: US 2014/0185314 A1
(43) Pub. Date: Jul. 3, 2014

(54) Edge Lit LED Header System

(71) Applicants: Richard Schattinger, New York, NY (US); Derek J. Gabriels, Bay Shore, NY (US)

(72) Inventors: Richard Schattinger, New York, NY (US); Derek J. Gabriels, Bay Shore, NY (US)

(21) Appl. No.: 13/917,231

(22) Filed: Jun. 13, 2013

Related U.S. Application Data
(60) Provisional application No. 61/658,932, filed on Jun. 13, 2012.

(51) Int. Cl. G09F 13/18

(52) U.S. Cl. CPC G09F 13/18
USPC 362/602

(57) ABSTRACT

A LED illuminated system to illuminate a messaging panel may include a main housing, an edge lit messaging panel to be detachably connected to the main housing, a blackout panel to be detachably connected to the main housing and to cooperate with the edge lit messaging panel, a front LED light element to edge light the edge the messaging panel and positioned within the main housing, and a back LED light element to provide an angled light and positioned within the main housing.

### PRIORITY

The present invention claims priority under 35 USC section 119 and based on a provisional application with a Ser. No. 61/658,932 which was filed on Jun. 13, 2012.

### FIELD OF THE INVENTION

This invention is directed to an edge-lit backlighting and strip light system for light emitting diode displays, and, more particularly, to a strip light system employing a number of light strips in the form of thin, light weight sections of a substrate each of which mounts a plurality of light engines having an array of densely packed, primary color light emitting diodes (“LEDs”).

### BACKGROUND

In recent years, there have been developed light-emitting diodes capable of emitting red, green, and blue colors (hereinafter referred to as “RGB” in some cases) and light-emitting diodes which are formed of light emitting elements in combination with phosphor materials so that they emit various colors, such as a white color, with a high brightness. Since a light-emitting diode (hereinafter referred to as an “LED”) is a solid-state element, it has superior resistance against vibration, a low-power consumption rate, a long operating life, and superior drive properties such as a high-speed drive. Accordingly, the light-emitting diodes have been increasingly used for various applications such as light sources for signal heads and full-color LED displays.

Light-emitting diode devices having various sizes and display effects have been developed and are available in the market. Depending on the complexity of required illumination pattern, most of the light-emitting diode devices include arrays of light-emitting diodes selectively switched on/off to generate such illumination pattern. When a complex illumination pattern is desired, the number of required light-emitting diodes can be significant. In addition, when the light-emitting diode devices are applied to an educational toy, the educational value is limited to the image only.

The light emitting diode devices may suffer from hot spots which may result in some of the light emitting diodes providing more light than others. This may result in an uneven lighting effect which may be cosmetic undesirable.

### SUMMARY

A LED illuminated system to illuminate a messaging panel may include a main housing, an edge lit messaging panel to be detachably connected to the main housing, a blackout panel to be detachably connected to the main housing and to cooperate with the edge lit messaging panel, a front LED light element to edge light the edge the messaging panel and positioned within the main housing, and a back LED light element to provide an angled light and positioned within the main housing.

The edge lit messaging panel may be nondestructively removed and replaced.

The main housing may be connected to a back LED driver housing.

The LED illumination system may include support arms to connect the main housing with the back LED the driver housing

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the LED illuminated system of the present invention;

FIG. 2 illustrates another side view of the LED illuminated system of the present invention;

FIG. 3 illustrates a an exploded view of the LED edge-lit panel and the spacer device of the LED illuminated system of the present invention;

FIG. 4 illustrates a side perspective view of the LED edge-lit panel and the spacer device of the LED illuminated system of the present invention;

FIG. 5 illustrates a front perspective view of the LED illuminated system of the present invention;

FIG. 6 illustrates an elevational view of the LED illustrated system of the present invention;

FIG. 7 illustrates a front view of the LED illustrated system of the present invention;

FIG. 8 illustrates a top view of the LED illustrated system of the present invention;

FIG. 9 illustrates a side view of the LED illumination system of the present invention;

FIG. 10 illustrates a side view of another embodiment of the LED illumination system of the present invention;

FIG. 11 illustrates a front view of another embodiment of the LED illumination system of the present invention;

FIG. 12 illustrates a rearview of another embodiment of the LED illumination system of the present invention;

FIG. 13 illustrates a perspective view of a portion of the LED illuminated system of the present invention;

FIG. 14 illustrates a side view of the LED illuminated system of the present invention.

FIG. 15 illustrates a front view of the LED illuminated system of the present invention.

FIG. 16 illustrates a rearview of the LED illuminated system of the present invention.

FIG. 17 illustrates a perspective view of the LED illuminated system of the present invention;

FIGS. 18-23 illustrates the LED illuminated system of the present invention.

### DETAILED DESCRIPTION

The LED illuminated system 100 of the present invention may provide and LED edge lit panel which may include an LED array or LED modules which may be positioned along a single edge of a graphic frame (the LED edge-lit panel 102) to hold a acrylic panel 500 while hiding the LED array which may be a strip of at least two LED lights. The acrylic panel 500 may be nondestructive removable by sliding in and out and can be sized to accommodate different thicknesses of the acrylic panel 500.

### Hanging Header System

Impactful LED illuminated sign system 100 that delivers an illuminated message/image in addition to downward light from a main housing 200 . The LED illuminated system 100 may be used in retail environments to highlight categories and add lighting onto product positioned below and may also be used as a wall signage system for communication of a message while also providing downward lighting.

The elements may include:

### Edge-Lit Messaging Panels

Edge-Lit Messaging Panels 500 (glass, acrylic or other clear materials) with etched, screened or printed content onto one of the flat surface so that it illuminates when LED lighting spreads through the panel 500.

The present invention may work with or without a blackout panel 502 which can be applied to the backside to highlight the content/message/image The panels of the present invention can be customized in size (length, width & depth), shape and content.

### Blackout Panel

The blackout panel 502 may be formed from a separate opaque material such as from paper, plastic or printed materials or other appropriate materials.

The blackout panel 502 may be formed by screening/printing onto the back side of the flat surfaces of the Edge-lit messaging panel 504 in an opaque finish or other appropriate finish.

The blackout panel 502 may be a graphic treatment to highlight content or showcase an image/printed content on the messaging panels 504.

The blackout panel 502 may block anything (any light) from coming through from the back of the blackout panel 502 where the content is positioned and can also be used as a graphic treatment or to showcase image/printed content on the edge-lit panels 504.

Panels 502 504 can be customized in size and shape

### Main Housings

The main housing 301 may be made from metal or plastic and may include of a front metal frame 303 (extrusion profile) connected by support arms 401 that connect to a back LED driver housing 601 with securing brackets 603

The main housing 301 may be used to attach to retail fixtures or wall sets either on the top or on a front surface typically over product merchandised below the main housing 301

The main housing 301 may hold and secure the LED lighting mechanisms 701, messaging panel(s) 504 with or without blackout panel 502, downward lighting elements, driver 801 and cording 901 to allow for connecting one unit to another in long continues runs before having to be plugged into an electrical outlet

Support arms 401 secure the main housing 301 and can be curved as shown, straight, bent or other angles as long as they allow for the electrical wiring from the front LED Lighting Mechanisms 701 to past through to the back LED driver housing 601.

Size, shape and method of attachment for the securing brackets 603 on the back LED driver housing 601 can be modified to the environment it will be placed in.

The LED driver housing 601 includes the electrical wiring 901 that leads to the main housing 301 that provides and maintains the power transfer, electrical cords that connect one to the other.

### LED Lighting

The front LED Lighting element 703 which may be a strip of at least two LED lights extends directly over the edge-lit messaging panel 504 to allow a consistent flow of light through the panel 504, typically running the length of the panel 504.

The front LED lighting element 703 may illuminate the content on the edge-lit messaging panel(s) 504 as well as the edges of the edge lit messaging panel 504.

While shown as a separate part, this front LED lighting element 703 may be be incorporated directly into the edge-lit messaging panel 504 within a channel (not shown) routed into the panel 504.

The back LED lighting element 705 extends longitudinally in the back channel and projects light outward based on the angle of the position of the back LED lighting element 705.

The front LED light element 703 and the back LED light element 705 may be made up of multiple LED modules, single LED light fixture or LED strip lighting, wired directly to a power source (driver, convenience outlet, etc)

### Driver/Convenience Outlet

The driver 801 provides power for the front LED lighting element 703 and the back LED light element 705, and allows the lighting element 703 and 705 to be connected to power an adjacent lighting element 703 and 705 to connect one to the other (daisy-chain) in long continuous runs and then to a single electrical outlet or can be connected individually to an outlet to manage the electrical current to keep a consistent flow/transfer.

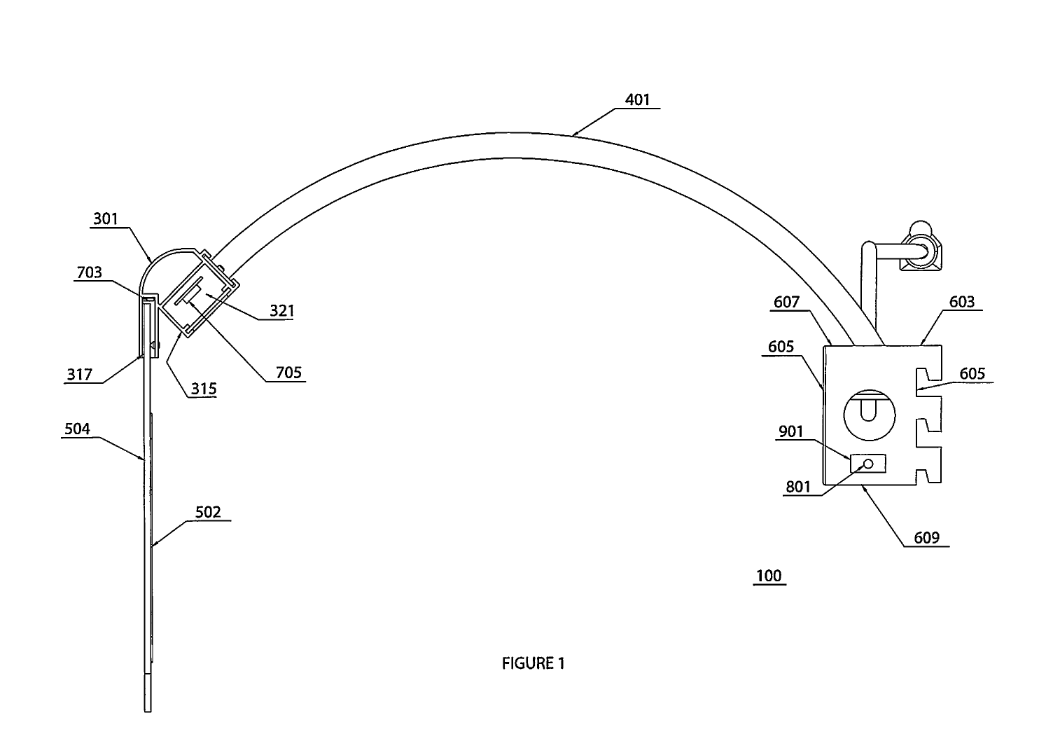

FIG. 1 illustrates a side view of the LED illuminated system 100 of the present invention and illustrates the main housing 301 which may include a top curved wall 311 which may connect to a securing bracket 313 which may be opposed to a sidewall 315 which may connect to a U-shaped wall 317. The securing bracket 313 and the side wall 315 may be connected to a LED lens 319 which may be transparent. The back LED lighting element 705 may be positioned within a cavity 321 which may be defined by the top wall 323, the securing bracket 313, the side wall 315 and the LED lens 319. The U-shaped wall may be detachably connected to the edge lit messaging panel 504 and the blackout panel 502. The front LED light element 703 may be positioned at the bottom of the U-shaped wall 317 and along the edge of the edge lit messaging panel 504 and the blackout panel 502.

The main housing 301 may be connected to the back LED driver housing 601 by support arms 401. The support arms 401 may terminate in securing brackets 603 in order to connect to the main housing 301 and the back LED driver housing 601. The back LED driver housing 601 may include a back top wall 603 which may be connected to a pair of opposing back side walls 605, a back front wall 607 which may extend beyond the sidewall 605 and a substantially mirror back wall 609 which may extend beyond the sidewall 605. A back bottom wall 609 may be opposed to the back top wall 603 and may be connected to the sidewall 605, the front wall 607 and the back wall 609.

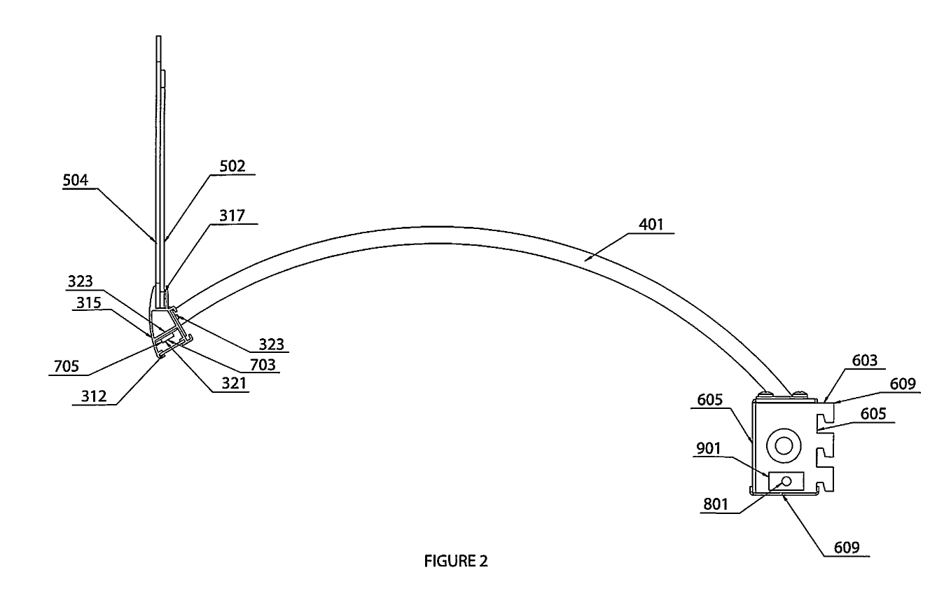

FIG. 2 illustrates a side view of the LED illuminated system 100 of the present invention and illustrates the main housing 301 which may include a top wall 312 which may connect to a securing bracket 313 which may be opposed to a sidewall 315 which may connect to a U-shaped wall 317. The securing bracket 313 and the side wall 315 may be connected to a LED lens 319 which may be transparent. The back LED lighting element 705 may be positioned within a cavity 321 which may be defined by the top wall 323, the securing bracket 313, the side wall 315 and the LED lens 319. The U-shaped wall may be detachably connected to the edge lit messaging panel 504 and the blackout panel 502. The front LED light element 703 may be positioned at the bottom of the U-shaped wall 317 and along the edge of the edge lit messaging panel 504 and the blackout panel 502.

The main housing 301 may be connected to the back LED driver housing 601 by support arms 401. The support arms 401 may terminate in securing brackets 603 in order to connect to the main housing 301 and the back LED driver housing 601. The back LED driver housing 601 may include a back top wall 603 which may be connected to a pair of opposing back side walls 605, a back front wall 607 which may extend beyond the sidewall 605 and a substantially mirror back wall 609 which may extend beyond the sidewall 605. A back bottom wall 609 may be opposed to the back top wall 603 and may be connected to the sidewall 605, the front wall 607 and the back wall 609.

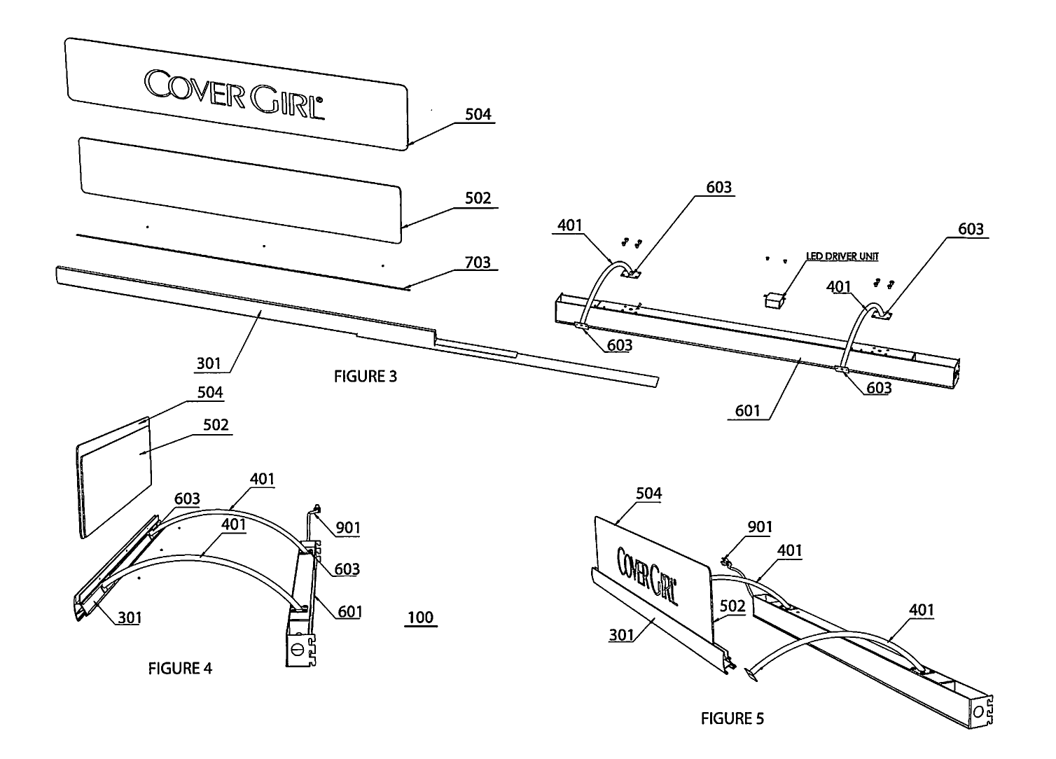

FIG. 3 illustrates an exploded view of the LED illustrated system 100 and illustrates the edge lit messaging panel 504, the blackout panel 503, the main housing 301, the support arms 401, the back LED driver housing 601, the securing brackets 603, the driver 801, and the front LED lighting element 703.

FIG. 4 illustrates an exploded view of the LED illustrated system 100 and illustrates the edge lit messaging panel 504, the blackout panel 503, the main housing 301, the support arms 401, the back LED driver housing 601, the securing brackets 603, the driver 801, and the front LED lighting element 703.

FIG. 5 illustrates an exploded view of the LED illustrated system 100 and illustrates the edge lit messaging panel 504, the blackout panel 503, the main housing 301, the support arms 401, the back LED driver housing 601, the securing brackets 603, the driver 801, and the front LED lighting element 703.

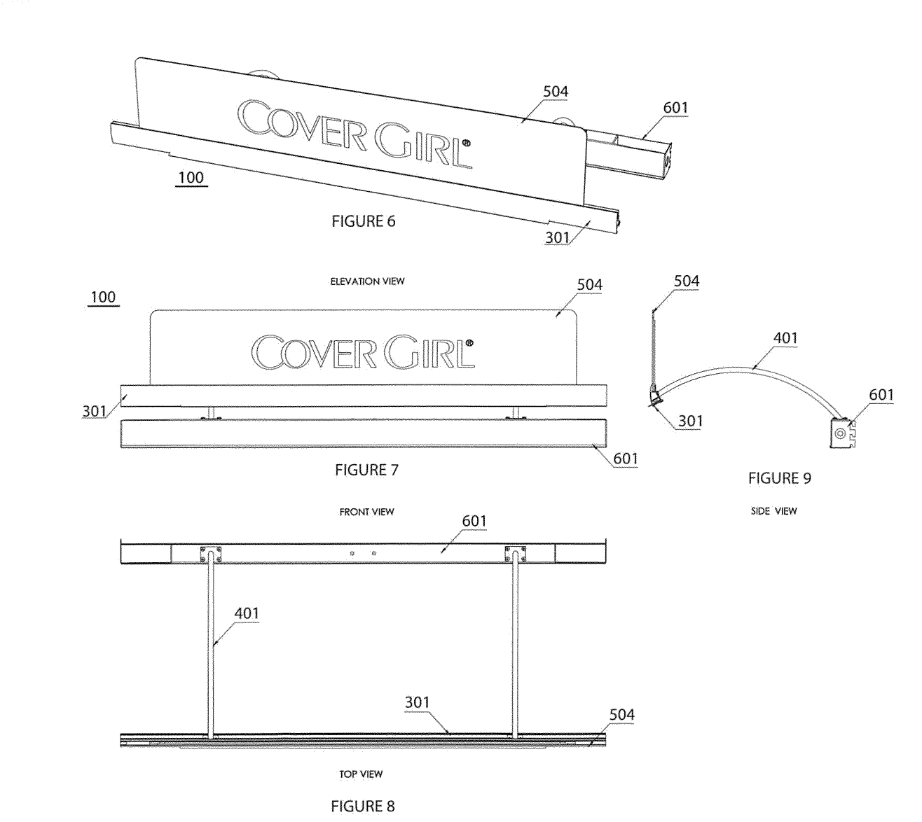

FIG. 6 illustrates an elevation view of the LED illuminated system 100 and illustrates the main housing 301, the edge lit message panel 504, the back LED driver housing 601.

FIG. 7 illustrates a front view of the LED illuminated system 100 and illustrates the main housing 301, the edge lit message panel 504, the back LED driver housing 601.

FIG. 8 illustrates a top view of the LED illuminated system 100 and illustrates the main housing 301, the edge lit message panel 504, the back LED driver housing 601.

FIG. 9 illustrates a side view of the LED illuminated system 100 and illustrates the main housing 301, the edge lit message panel 504, the back LED driver housing 601.

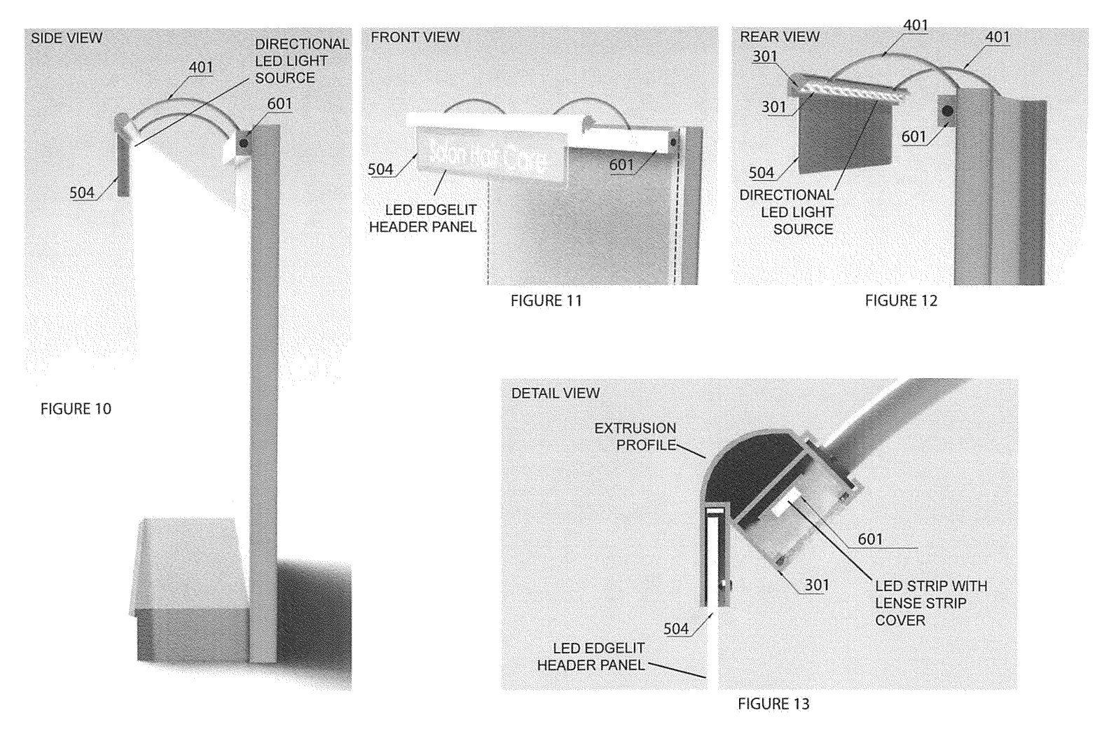

FIG. 10 illustrates a side perspective view of the mounted LED illuminated system 100 and illustrates the main housing 301, the edge lit message panel 504, the back LED driver housing 601. Further, the back LED light element 705 which may be directional is illustrated.

FIG. 11 illustrates a front perspective view of the mounted LED illuminated system 100 and illustrates the main housing 301, the edge lit message panel 504, the back LED driver housing 601. Further, the back LED light element 705 which may be directional is illustrated.

FIG. 12 illustrates a rear perspective view of the mounted LED illuminated system 100 and illustrates the main housing 301, the edge lit message panel 504, the back LED driver housing 601. Further, the back LED light element 705 which may be directional is illustrated.

FIG. 13 illustrates a portion of the LED illuminated system 100 of the present invention.

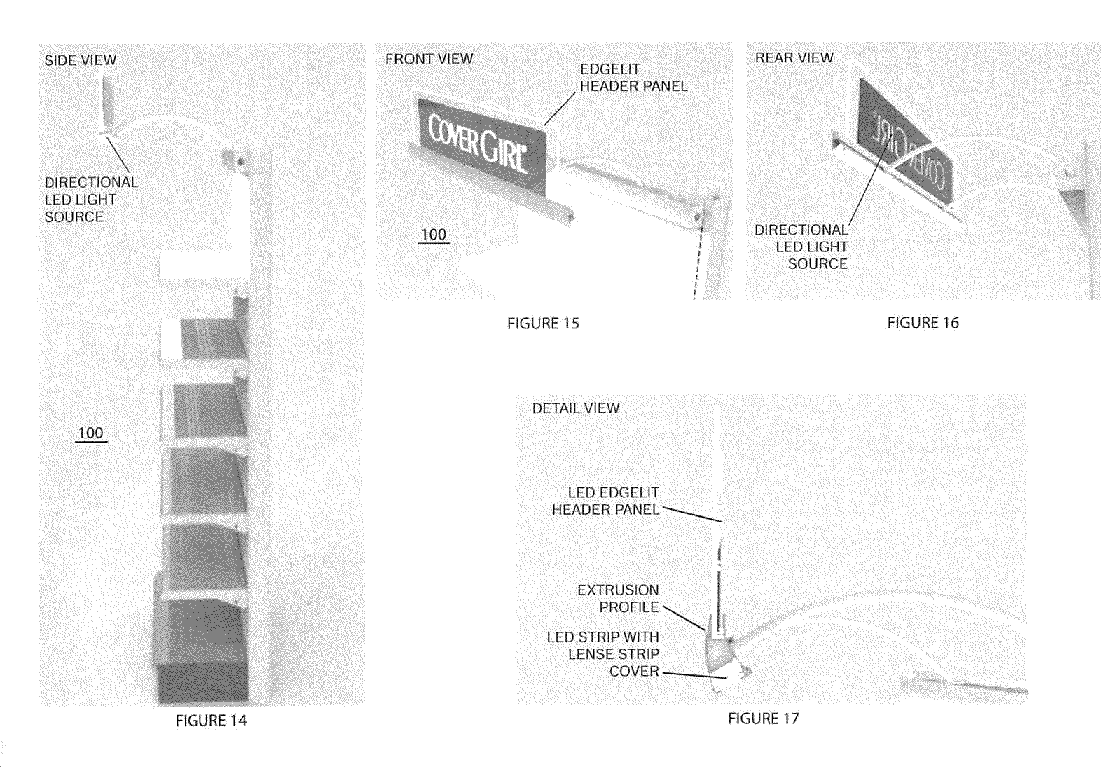

FIG. 14 illustrates a side view of the LED illuminated system 100 of the present invention.

FIG. 15 illustrates a front view of the LED illuminated system 100 of the present invention.

FIG. 16 illustrates a rearview of the LED illuminated system 100 of the present invention.

FIG. 17 illustrates a perspective view of the LED illuminated system 100 of the present invention.

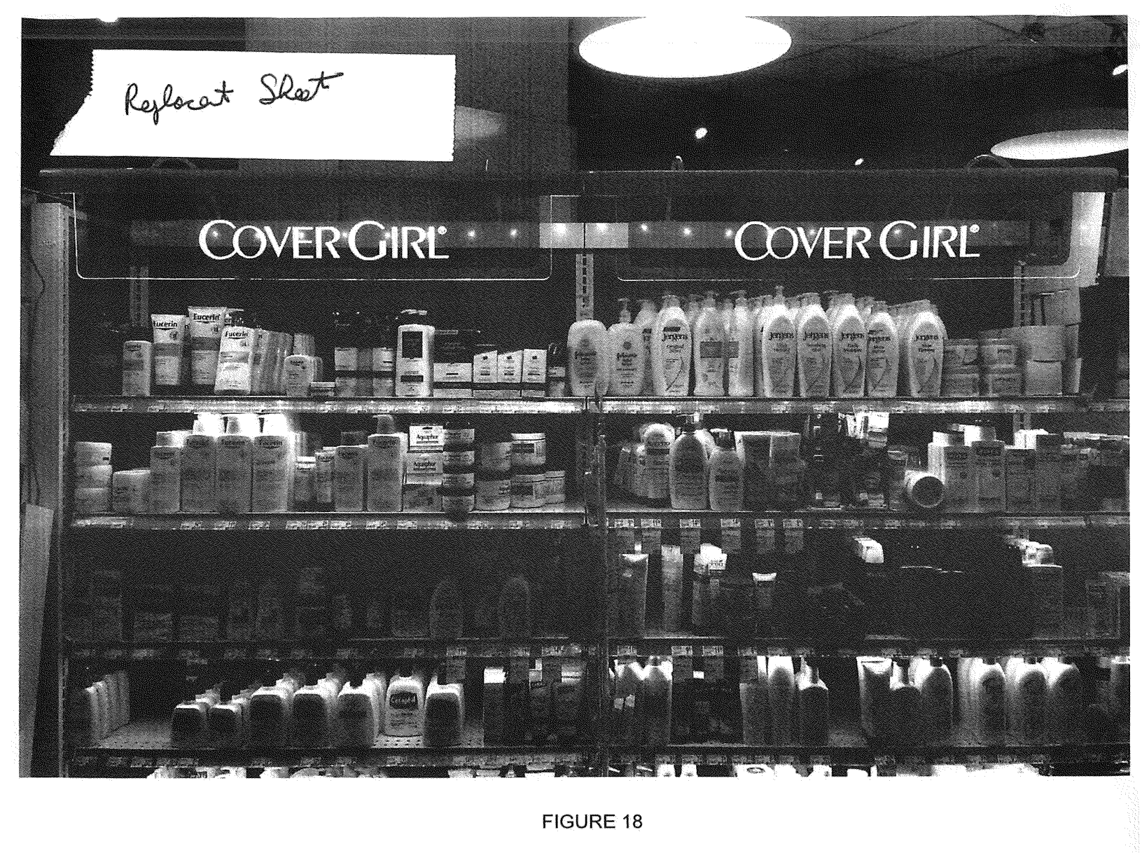

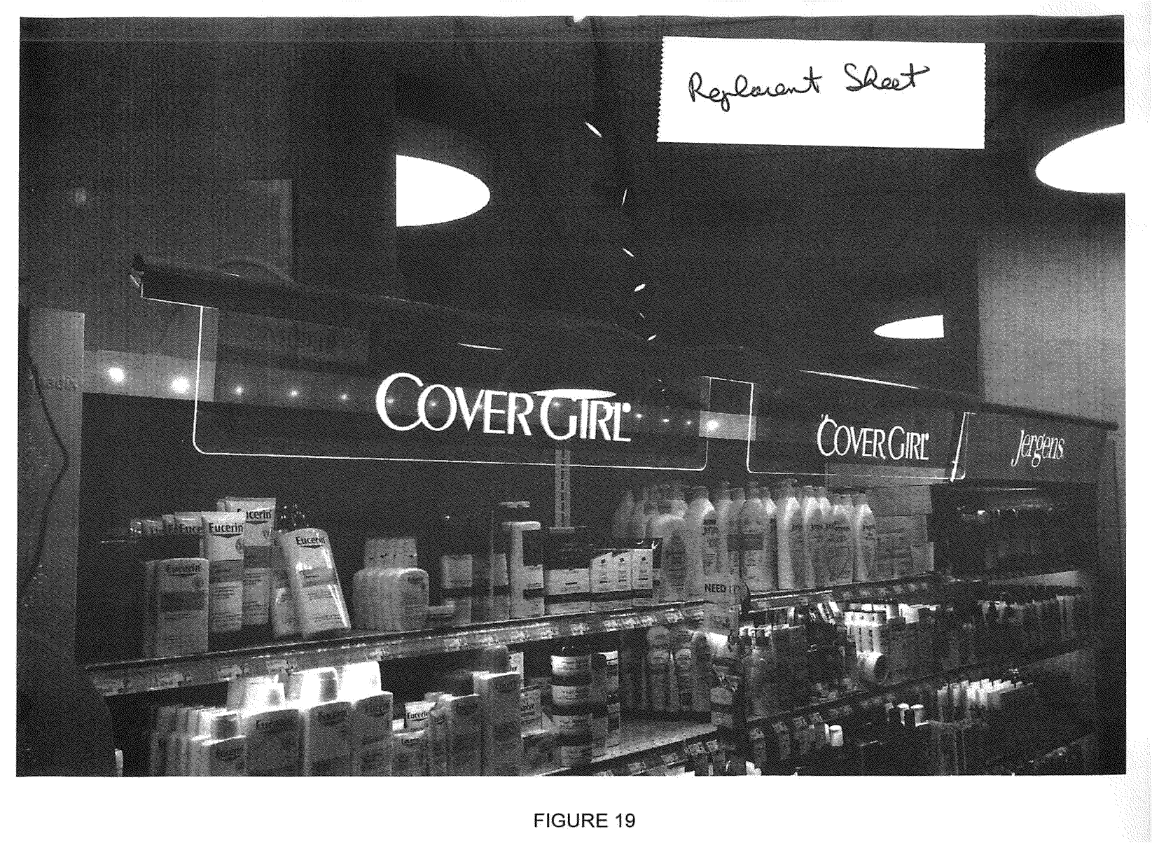

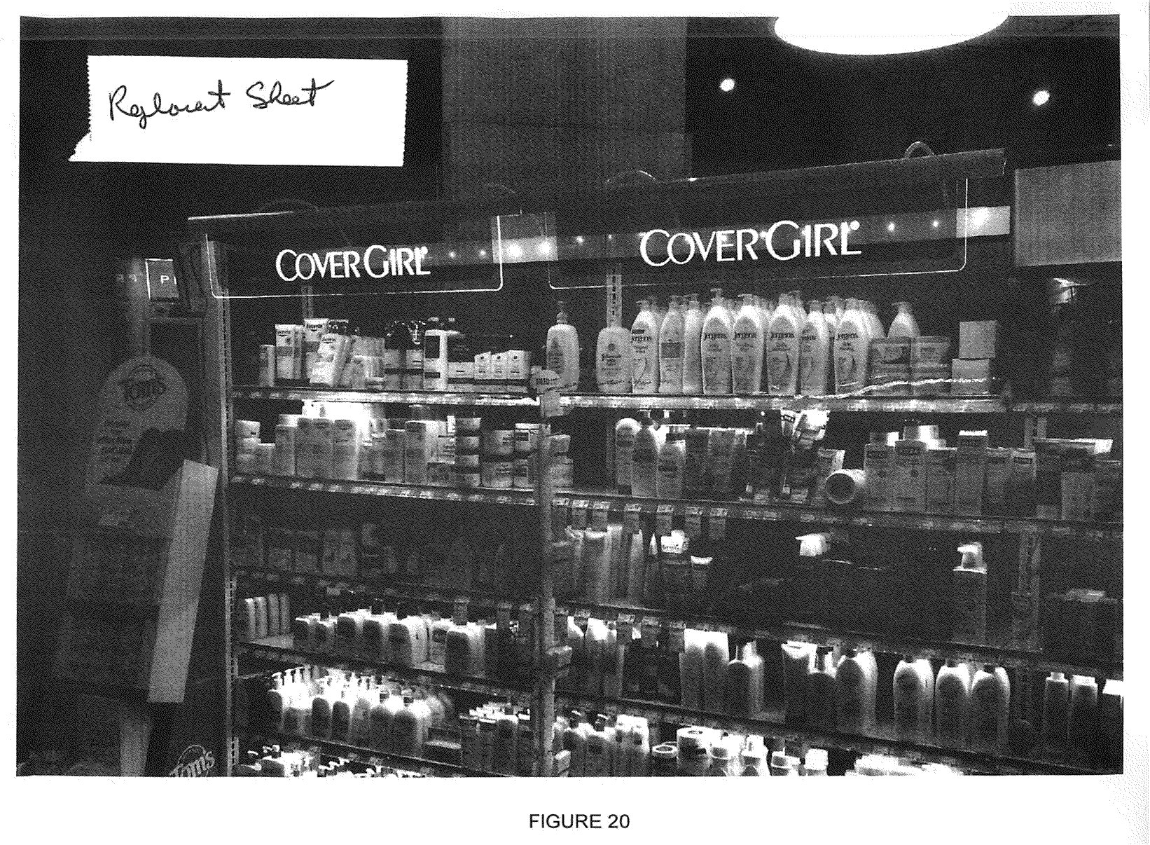

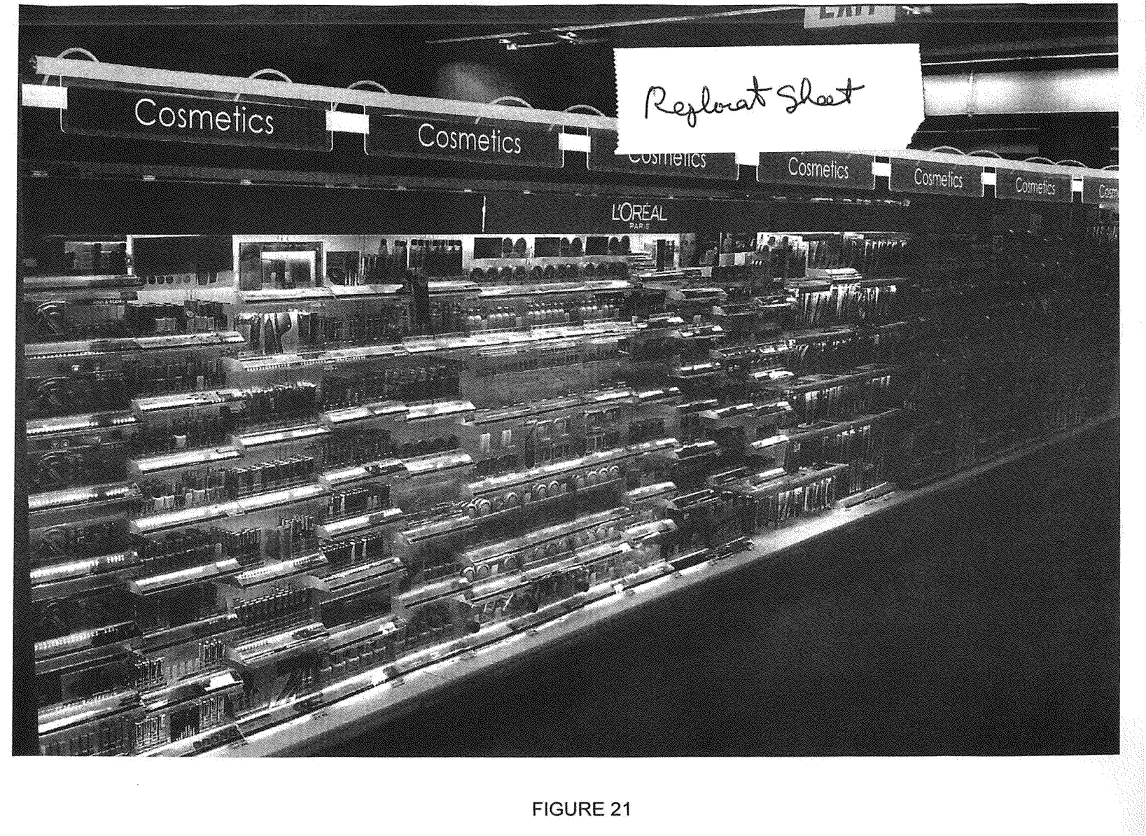

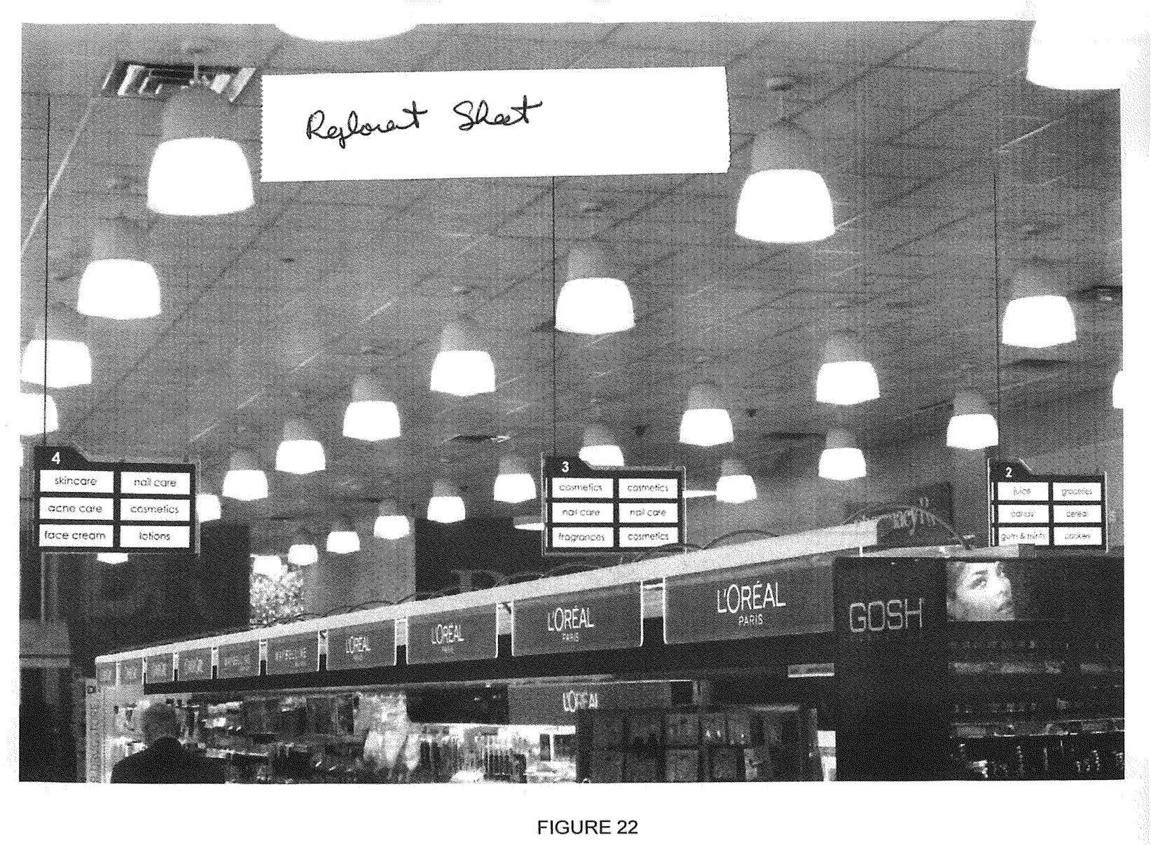

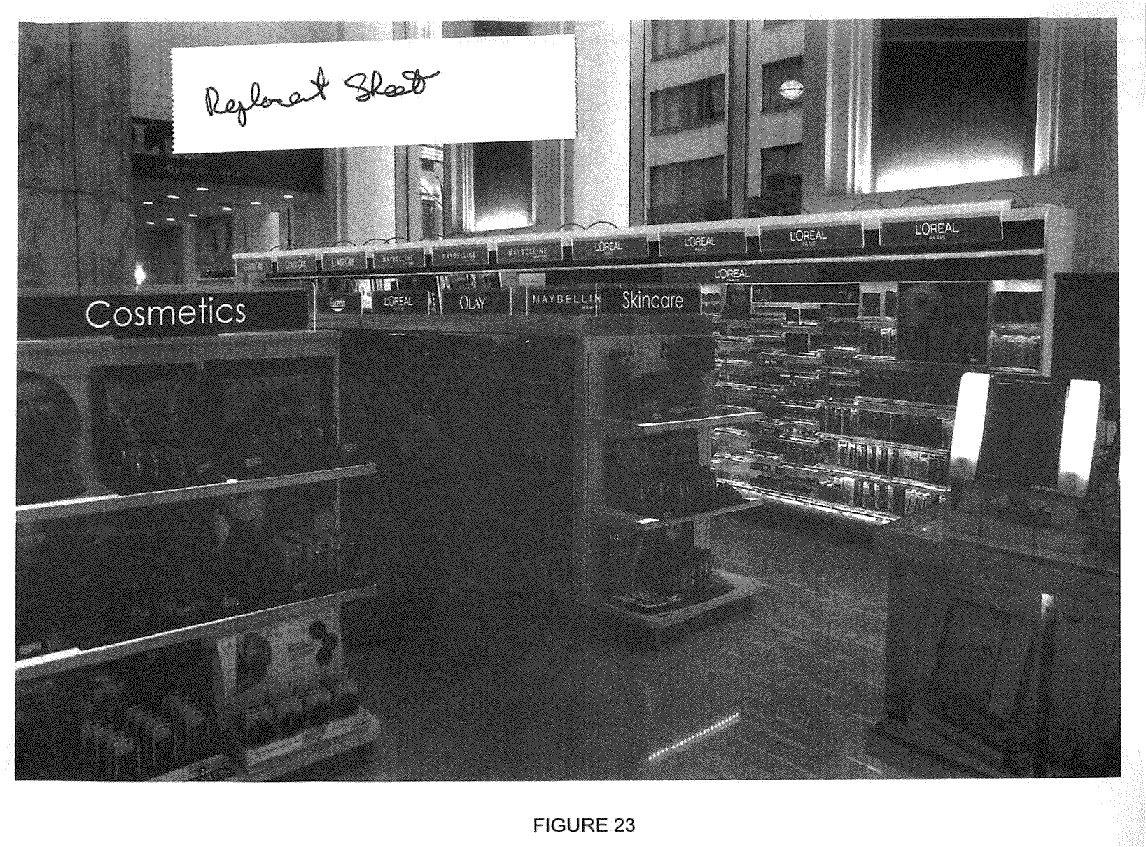

FIGS. 18-23 illustrates a perspective view of the LED illuminated system of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A LED illuminated system to illuminate a messaging panel, comprising:
a main housing;
an edge lit messaging panel to be detachably connected to the main housing;
a blackout panel to be detachably connected to the main housing and to cooperate with the edge lit messaging panel;
a front LED light element to edge light the edge the messaging panel and positioned within the main housing;
a back LED light element to provide an angled light and positioned within the main housing.

2. A LED illuminated system to illuminate a messaging panel as in claim 1, wherein the edge lit messaging panel is nondestructively removed and replaced.

3. A LED illuminated system to illuminate a messaging panel as in claim 1, wherein the main housing is connected to a back LED driver housing.

4. A LED illuminated system to illuminate a messaging panel as in claim 3, wherein the LED illumination system includes support arms to connect the main housing with the back LED the driver housing
